(19) United States
(12) Patent Application Publication
(10) Pub. No.: US 2024/0412917 A1
(43) Pub. Date: Dec. 12, 2024

(54) COIL COMPONENT

(71) Applicant: TDK Corporation, Tokyo (JP)

(72) Inventors: Takeshi YOKOYAMA, Tokyo (JP); Toshiyuki ABE, Tokyo (JP); Yuki HASHIMOTO, Tokyo (JP); Takeshi OKUMURA, Tokyo (JP); Tomonaga NISHIKAWA, Tokyo (JP)

(21) Appl. No.: 18/696,745

(22) PCT Filed: Jun. 27, 2022
(86) PCT No.: PCT/JP2022/025485

§ 371 Date: Mar. 28, 2024

(30) Foreign Application Priority Data
Sep. 30, 2021 (JP) 2021-160980

(51) Int. Cl. H01F 27/28; H01F 27/24; H01F 27/29; H01F 27/32

(52) U.S. Cl. CPC H01F 27/2804; H01F 27/24; H01F 27/292; H01F 27/323; H01F 2027/2809

(57) ABSTRACT

To prevent the occurrence of a short-circuit failure through a magnetic body layer. A coil component includes interlayer insulating films and conductor layers which are alternately stacked on a magnetic body layer. The conductor layers respectively have coil patterns, terminal patterns which are provided at positions overlapping a terminal electrode, and terminal patterns which are provided at positions overlapping a terminal electrode. The terminal patterns are connected to the terminal electrode, and the terminal patterns are connected to the terminal electrode. The terminal pattern is insulated from the terminal electrode. This can prevent a short circuit failure between a coil pattern or terminal pattern and the terminal pattern through the magnetic body layer.

### TECHNICAL FIELD

The present invention relates to a coil component and, more particularly, to a coil component having a structure in which a plurality of interlayer insulating films and a plurality of conductor layers are alternately stacked on a magnetic body layer.

### BACKGROUND ART

Patent Document 1 discloses a coil component having a structure in which a plurality of interlayer insulating films and a plurality of conductor layers are alternately stacked on a magnetic body layer.

### CITATION LIST

### [Patent Document]

[Patent Document 1] JP 2017-11185A

### SUMMARY OF THE INVENTION

### Problem to be Solved by the Invention

However, when the magnetic body layer contains a metal magnetic material such as Fe, a short-circuit failure may occur, through the magnetic body layer, between conductor patterns which belong to a lowermost conductor layer and are applied with different potentials. Such a problem becomes prominent when the film thickness of an interlayer insulating film positioned between the magnetic body layer and the lowermost conductor layer is small.

It is therefore an object of the present invention to prevent, in a coil component having a structure in which a plurality of interlayer insulating films and a plurality of conductor layers are alternately stacked on a magnetic body layer, the occurrence of a short-circuit failure through the magnetic body layer.

### Means for Solving the Problem

A coil component according to the present embodiment includes: a first magnetic body layer; and a plurality of interlayer insulating films and a plurality of conductor layers alternately stacked on the first magnetic body layer. The plurality of conductor layers include a first conductor layer closest to the first magnetic body layer, a second conductor layer farthest from the first magnetic body layer, and a plurality of third conductor layers positioned between the first and second conductor layers. The plurality of interlayer insulating films include a first interlayer insulating film positioned between the first magnetic body layer and the first conductor layer, a second interlayer insulating film covering the second conductor layer, and a plurality of third interlayer insulating films positioned between the first and second interlayer insulating films. Each of the plurality of conductor layers includes a coil pattern, a first terminal pattern, and a second terminal pattern. The first terminal patterns included in the respective first conductor layer, second conductor layer, and plurality of third conductor layers are connected to one another through via conductors penetrating respectively the plurality of third interlayer insulating films. The second terminal patterns included in the respective second conductor layer and plurality of third conductor layers are connected to one another through via conductors penetrating respectively the plurality of third interlayer insulating films. The second terminal pattern included in the first conductor layer is insulated from the second terminal patterns included in the plurality of respective third conductor layers.

According to the present invention, the second terminal pattern included in the first conductor layer and the second terminal pattern included in the third conductor layer are insulated from each other, so that it is possible to prevent a short-circuit failure, through the magnetic body layer, between the coil pattern or first terminal pattern included in the first conductor layer and the second terminal pattern included in the first conductor layer. Thus, even when the film thickness of the first interlayer insulating film is small, product reliability can be increased

The coil component according to the present invention may further include a first terminal electrode provided at a position overlapping, through the second interlayer insulating film, the first terminal pattern included in the second conductor layer and a second terminal electrode provided at a position overlapping, through the second interlayer insulating film, the second terminal pattern included in the second conductor layer, and the first and second terminal patterns included in the second conductor layer may be connected respectively to the first and second terminal electrodes through via conductors penetrating the second interlayer insulating film. This allows the terminal electrodes to be arranged on the surface of the coil component perpendicular to the coil axis direction.

The coil component according to the present invention may further include a first terminal electrode provided on first side surfaces of the plurality of third interlayer insulating films and a second terminal electrode provided on second side surfaces of the plurality of third interlayer insulating films, the first terminal patterns included in the respective first conductor layer, second conductor layer, and the plurality of third conductor layers may be exposed to the first side surfaces to contact the first terminal electrode, and the second terminal patterns included in the respective second conductor layer and the plurality of third conductor layers may be exposed to the second side surfaces to contact the second terminal electrode. This allows the terminal electrodes to be arranged on the side surface of the coil component parallel to the coil axis direction.

In the present invention, the second terminal pattern included in the first conductor layer may be in a floating state or may be connected to the coil pattern included in the first conductor layer. In either case, it is possible to prevent a short-circuit failure through the magnetic body layer.

In the present invention, the second terminal pattern included in the first conductor layer may be embedded in the third interlayer insulating film so as not to expose a side surface thereof. Thus, even when barrel plating is performed, a barrel plating layer is not formed on the second terminal pattern included in the first conductor layer.

In the present invention, the second terminal pattern included in the first conductor layer may be divided into a plurality of numbers by a slit. This allows adjustment of process conditions or the like.

The coil component according to the present invention may further include a second magnetic body layer that covers the second conductor layer through the second interlayer insulating film, and the second interlayer insulating film may be thicker than the first interlayer insulating film. This makes it possible to prevent the occurrence of a short-circuit failure through the second magnetic body layer.

### Advantageous Effects of the Invention

As described above, according to the present invention, it is possible to prevent, in a coil component having a structure in which a plurality of interlayer insulating films and a plurality of conductor layers are alternately stacked on a magnetic body layer, the occurrence of a short-circuit failure through the magnetic body layer.

### BRIEF DESCRIPTION OF THE DRAWINGS

FIG. 1 is a schematic transparent perspective view for explaining the structure of a coil component 1 according to a first embodiment of the present invention.

FIG. 2 is a schematic cross-sectional view taken along the line A-A illustrated in FIG. 1.

FIG. 3 is a schematic plan view for explaining pattern shapes of the conductor layers L1, L3, L5, and L7 as viewed from the magnetic body layer M1 side.

FIG. 4 is a schematic plan view for explaining pattern shapes of the conductor layers L2, L4, L6, and L8 as viewed from the magnetic body layer M1 side.

FIG. 5 is an equivalent circuit of the coil component 1.

FIG. 6 is a schematic transparent perspective view for explaining the structure of a coil component 2 according to a second embodiment of the present invention.

FIG. 7 is a schematic cross-sectional view for explaining the structure of a coil component 3 according to a third embodiment of the present invention.

FIG. 8 is a schematic cross-sectional view for explaining the structure of a coil component 4 according to a fourth embodiment of the present invention.

FIG. 9 is a schematic cross-sectional view for explaining the structure of a coil component 5 according to a fifth embodiment of the present invention.

FIGS. 10A and 10B are schematic plan views showing pattern shapes of terminal patterns 13 and 14 according to modifications.

### MODE FOR CARRYING OUT THE INVENTION

Hereinafter, preferred embodiments of the present invention will be described in detail with reference to the accompanying drawings.

### First Embodiment

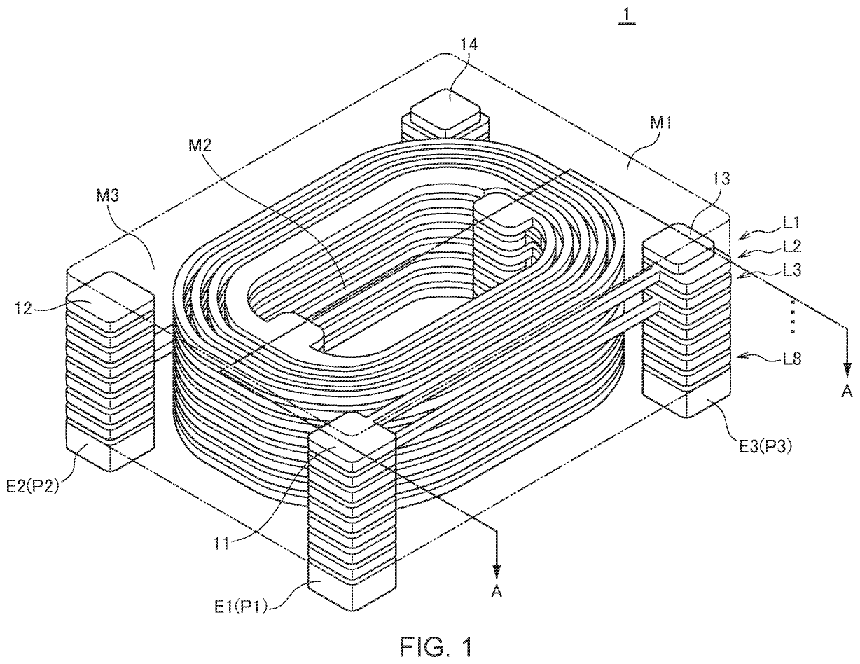

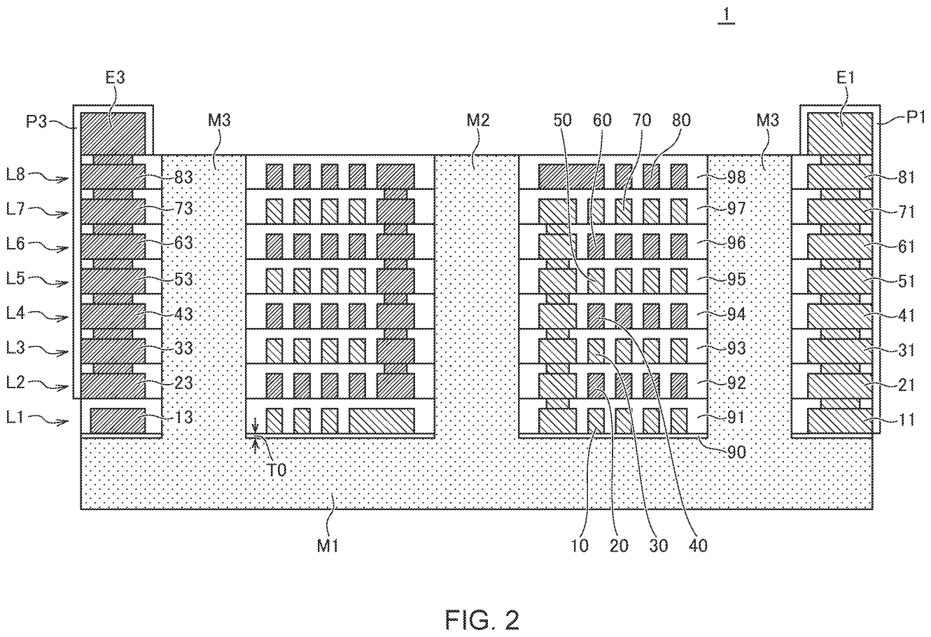

FIG. 1 is a schematic transparent perspective view for explaining the structure of a coil component 1 according to a first embodiment of the present invention. FIG. 2 is a schematic cross-sectional view taken along the line A-A illustrated in FIG. 1.

The coil component 1 according to the first embodiment of the present invention is a surface-mount type balun transformer and includes, as illustrated in FIGS. 1 and 2, interlayer insulating films 90 to 98 and conductor layers L1 to L8 which are alternately stacked on a magnetic body layer M1, magnetic body layers M2 and M3, and bump terminal electrodes E1 to E4. The conductor layer L1 is a conductor layer closest to the magnetic body layer M1, and the conductor layer L8 is a layer farthest from the magnetic body layer M1. The conductor layers L2 to L7 are positioned between the conductor layers L1 and L8. The interlayer insulating film 90 in the lowermost layer is positioned between the magnetic body layer M1 and the conductor layer L1. The interlayer insulating films 91 to 98 cover the conductor layers L1 to L8, respectively. The interlayer insulating film 98 in the uppermost layer is positioned between the conductor layer L8 and the terminal electrodes E1 to E4.

The conductor layers L1 to L8 respectively have coil patterns 10, 20, 30, 40, 50, 60, 70, and 80. The magnetic body layer M2 is provided in the inner diameter areas of the coil patterns 10, 20, 30, 40, 50, 60, 70, and 80, and the magnetic body layer M3 is provided in the outside areas of the coil patterns 10, 20, 30, 40, 50, 60, 70, and 80. The magnetic body layers M1 to M3 are each made of a composite member containing a metallic magnetic filler made of iron (Fe), a permalloy-based material, or the like and a resin binder and forms a magnetic path for magnetic flux generated by a current flowing in the coil patterns 10, 20, 30, 40, 50, 60, 70, and 80. The resin binder is preferably epoxy resin of liquid or powder.

The terminal electrodes E1 and E2 are used as a primary-side terminal (unbalanced signal terminal) for example, and the terminal electrodes E3 and E4 are used as a secondary-side terminal (balanced signal terminal), for example. In this case, one of the terminal electrodes E1 and E2 constituting the unbalanced signal terminal is connected to an unbalanced transmission line, and the other one thereof is connected to a ground wiring. The terminal electrodes E3 and E4 are connected to a pair of balanced transmission lines.

The coil patterns 10, 30, 50, and 70 positioned respectively in the conductor layers L1, L3, L5, and L7 are connected between the terminal electrodes E1 and E2. The coil patterns 20, 40, 60, and 80 positioned respectively in the conductor layers L2, L4, L6, and L8 are connected between the terminal electrodes E3 and E4.

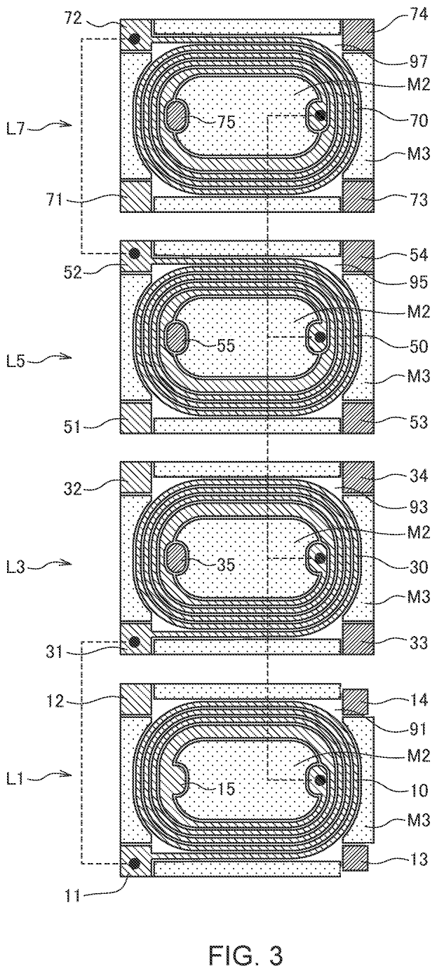

FIG. 3 is a schematic plan view for explaining pattern shapes of the conductor layers L1, L3, L5, and L7 as viewed from the magnetic body layer M1 side.

As illustrated in FIG. 3, the conductor layer L1 has terminal patterns 11 to 14 in addition to the coil pattern 10, the conductor layer L3 has terminal patterns 31 to 34 in addition to the coil pattern 30, the conductor layer L5 has terminal patterns 51 to 54 in addition to the coil pattern 50, and the conductor layer L7 has terminal patterns 71 to 74 in addition to the coil pattern 70. The terminal patterns 11, 31, 51, and 71 are short-circuited to one another, the terminal patterns 12, 32, 52, and 72 are short-circuited to one another, the terminal patterns 33, 53, and 73 are short-circuited to one another, and the terminal patterns 34, 54, and 74 are short-circuited to one another. The terminal pattern 13 is not short-circuited but insulated from the terminal patterns 33, 53, and 73, and the terminal pattern 14 is not short-circuited but insulated from the terminal patterns 34, 54, and 74. The outer peripheral ends of the coil patterns 10 and 30 included in the conductor layers L1 and L3 are connected respectively to the terminal patterns 11 and 31. The outer peripheral ends of the coil patterns 50 and 70 included in the conductor layers L5 and L7 are connected respectively to the terminal patterns 52 and 72. The inner peripheral ends of the coil patterns 10, 30, 50, and 70 included in the conductor layers L1, L3, L5, and L7 are short-circuited to one another.

The coil patterns 10 and 30 are each wound in the counterclockwise direction (left-hand direction) from its outer peripheral to inner peripheral ends, and the coil patterns 50 and 70 are each wound in the clockwise direction (right-hand direction) from its outer peripheral to inner peripheral ends. Relay patterns 35, 55, and 75 included in the respective conductor layers L3, L5, and L7 are independent of the coil patterns 30, 50, and 70, respectively, and connected to the inner peripheral ends of the coil patterns 20, 40, 60, and 80 to be described later. A dummy pattern 15 provided in the conductor layer L1 is a pattern for preventing a level difference from occurring at this portion in the upper conductor layers L2 to L8.

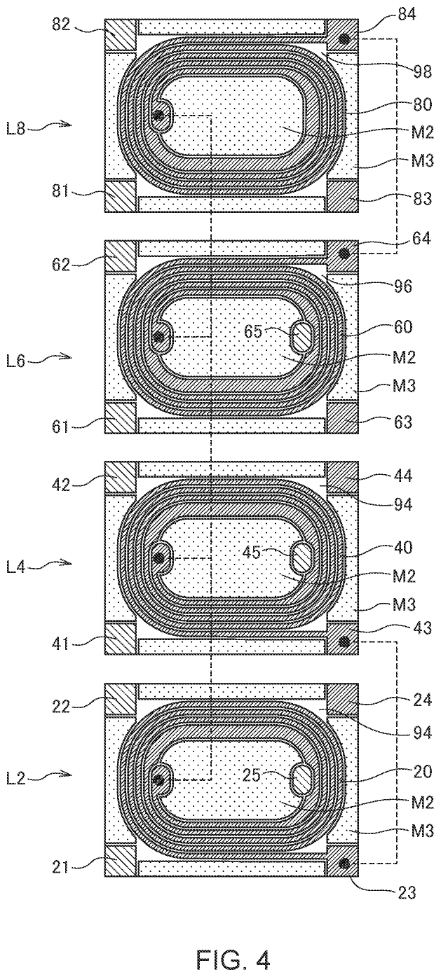

FIG. 4 is a schematic plan view for explaining pattern shapes of the conductor layers L2, L4, L6, and L8 as viewed from the magnetic body layer M1 side.

As illustrated in FIG. 4, the conductor layer L2 has terminal patterns 21 to 24 in addition to the coil pattern 20, the conductor layer L4 has terminal patterns 41 to 44 in addition to the coil pattern 40, the conductor layer L6 has terminal patterns 61 to 64 in addition to the coil pattern 60, and the conductor layer L8 has terminal patterns 81 to 84 in addition to the coil pattern 80. The terminal patterns 81 to 84 are connected respectively to the terminal electrodes E1 to E4 through via conductors formed in the interlayer insulating film 98. The terminal patterns 21, 41, 61, and 81 are short-circuited to one another, the terminal patterns 22, 42, 62, and 82 are short-circuited to one another, the terminal patterns 23, 43, 63, and 83 are short-circuited to one another, and the terminal patterns 24, 44, 64, and 84 are short-circuited to one another. The outer peripheral ends of the coil patterns 20 and 40 included in the conductor layers L2 and L4 are connected respectively to the terminal patterns 23 and 43. The outer peripheral ends of the coil patterns 60 and 80 included in the conductor layers L6 and L8 are connected respectively to the terminal patterns 64 and 84. The inner peripheral ends of the coil patterns 20, 40, 60, and 80 included in the conductor layers L2, L4, L6, and L8 are short-circuited to one another.

The coil patterns 20 and 40 are each wound in the clockwise direction (right-hand direction) from its outer peripheral to inner peripheral ends, and the coil patterns 60 and 80 are each wound in the counterclockwise direction (left-hand direction) from its outer peripheral to inner peripheral ends. Relay patterns 25, 45, and 65 included in the respective conductor layers L2, L4, and L6 are independent of the coil patterns 20, 40, and 60, respectively, and connected to the inner peripheral ends of the coil patterns 10, 30, 50, and 70.

The terminal patterns 11, 21, 31, 41, 51, 61, 71, and 81 are provided at positions overlapping the terminal electrode E1 in a plan view and connected to one another through via conductors penetrating respectively the interlayer insulating films 91 to 97. The terminal patterns 12, 22, 32, 42, 52, 62, 72, and 82 are provided at positions overlapping the terminal electrode E2 in a plan view and connected to one another through via conductors penetrating respectively the interlayer insulating films 91 to 97. The terminal patterns 23, 33, 43, 53, 63, 73, and 83 are provided at positions overlapping the terminal electrode E3 in a plan view and connected to one another through via conductors penetrating respectively the interlayer insulating films 92 to 97. The terminal patterns 24, 34, 44, 54, 64, 74, and 84 are provided at positions overlapping the terminal electrode E4 in a plan view and connected to one another through via conductors penetrating respectively the interlayer insulating films 92 to 97. The terminal patterns 13 and 14 are provided at positions overlapping respectively the terminal electrodes E3 and E4 but are independent patterns not connected to the other conductor patterns. That is, the terminal patterns 13 and 14 are each in an electrically floating state.

The side surfaces of all the terminal patterns, excluding the terminal patterns 13 and 14, are exposed from the interlayer insulating films 91 to 98 and are covered with barrel plating layers P1 to P4 as is the case with the surfaces of the terminal electrodes E1 to E4. On the other hand, the terminal patterns 13 and 14 are smaller in pattern size than the other terminal patterns and are thus embedded in the interlayer insulating film 91 without being exposed at their side surfaces therefrom. Therefore, even when barrel plating is performed, the barrel plating layers P3 and P4 are not formed on the side surfaces of the terminal patterns 13 and 14, ensuring insulation from the terminal electrodes E3 and E4.

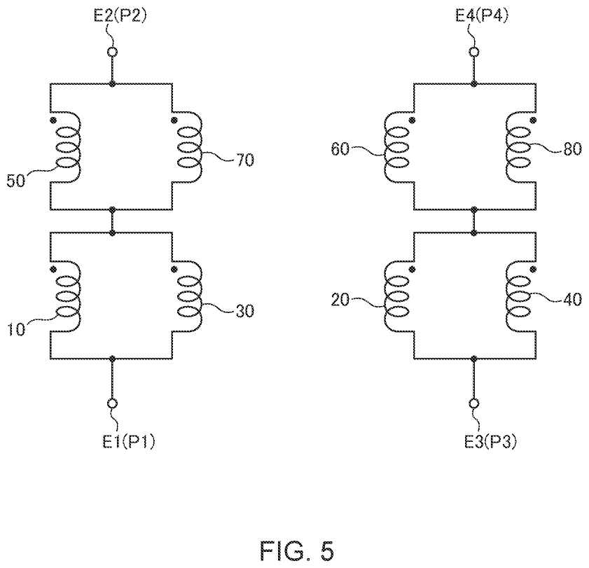

The coil component 1 according to the present embodiment has a structure in which the thus configured coil patterns 10, 30, 50, and 70 and the coil patterns 20, 40, 60, and 80 are coaxially alternately stacked. Thus, as illustrated in FIG. 5 which is an equivalent circuit diagram, the parallel-connected coil patterns 10, 30 and the parallel-connected coil patterns 50, 70 are connected in series between the terminal electrodes E1 and E2, and the parallel-connected coil patterns 20, 40 and the parallel-connected coil patterns 60, 80 are connected in series between the terminal electrodes E3 and E4. The number of turns of each of the coil patterns 10, 30, 50, and 70 is 4.5, so that a coil having a total of 9 turns is connected between the terminal electrodes E1 and E2. Similarly, the number of turns of each of the coil patterns 20, 40, 60 and 80 is 4.5, so that a coil having a total of nine turns is connected between the terminal electrodes E3 and E4.

As described above, in the coil component 1 according to the present embodiment, the parallel-connected coil patterns 10, 30 and the parallel-connected coil patterns 20, 40 are coaxially stacked in this order, and the parallel-connected coil patterns 50, 70 and the parallel-connected coil patterns 60, 80 are coaxially stacked in this order, making it possible to enhance a magnetic coupling between the coil patterns 10, 30, 50, 70 constituting a primary winding and the coil patterns 20, 40, 60, 80 constituting a secondary winding.

Further, since the terminal patterns 13 and 14 included in the conductor layer L1 are in a floating state, it is possible to prevent the occurrence of a short-circuit failure between the terminal patterns 13, 14 and the coil pattern 10 or the terminal patterns 11, 12 through the magnetic body layer M1. That is, when the terminal patterns 13 and 14 are connected respectively to the terminal patterns 23 and 24 belonging to the secondary side, a short-circuit failure may occur, through the magnetic body layer M1, between the terminal patterns 13, 14 and the coil pattern 10 or terminal patterns 11 and 12 belonging to the primary side; however, in the present embodiment, the terminal patterns 13 and 14 are in a floating state, so that even when a film thickness TO of the interlayer insulating film 90 is small, such a short-circuit failure does not occur. Further, when the terminal patterns 13 and 14 are simply omitted, a level difference occurs at this portion; however, in the present embodiment, such a level difference can be prevented.

### Second Embodiment

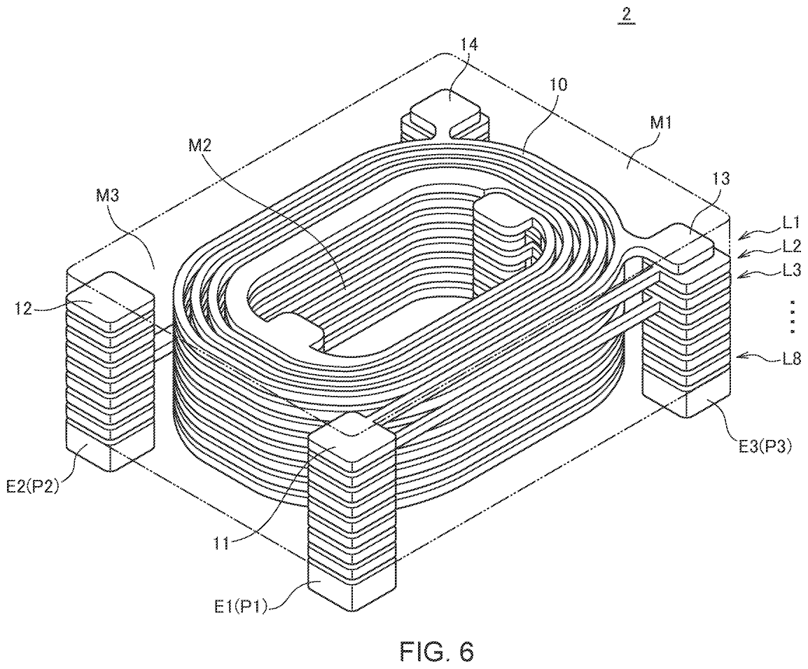

FIG. 6 is a schematic transparent perspective view for explaining the structure of a coil component 2 according to a second embodiment of the present invention.

As illustrated in FIG. 6, the coil component 2 according to the second embodiment differs from the coil component 1 according to the first embodiment in that the terminal patterns 13 and 14 are connected to the coil patterns 10. Other basic configurations are the same as those of the coil component 1 according to the first embodiment, so the same reference numerals are given to the same elements, and overlapping description will be omitted. As exemplified in the present embodiment, the terminal patterns 13 and 14 may not necessarily be in a floating state but may be connected to the coil pattern 10 belonging to the primary side.

### Third Embodiment

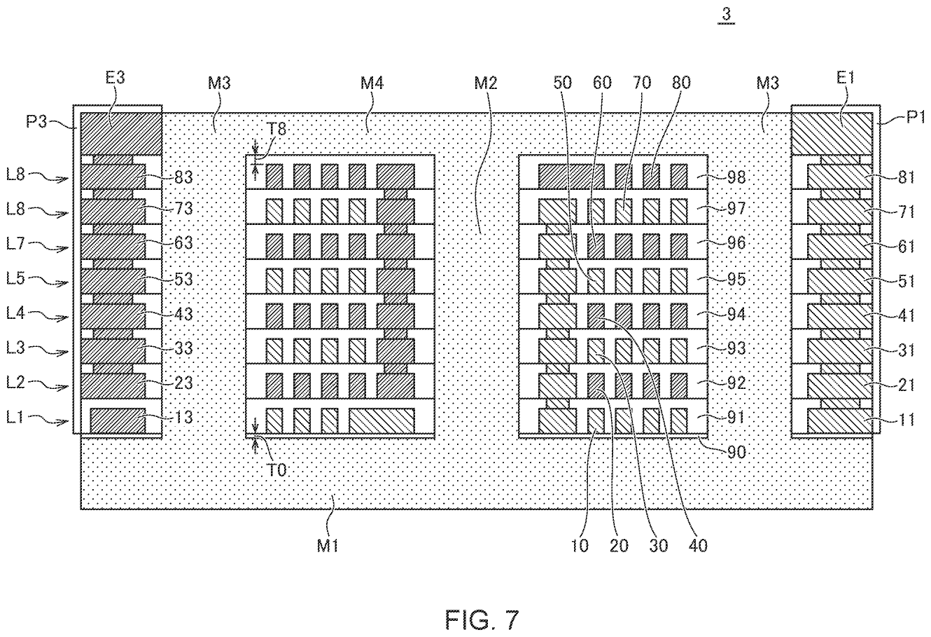

FIG. 7 is a schematic cross-sectional view for explaining the structure of a coil component 3 according to a third embodiment of the present invention, which corresponds to the cross section illustrated in FIG. 2.

As illustrated in FIG. 7, the coil component 3 according to the third embodiment differs from the coil component 1 according to the first embodiment in that it further has a magnetic body layer M4 covering the conductor layer L8 through the interlayer insulating film 98. Other basic configurations are the same as those of the coil component 1 according to the first embodiment, so the same reference numerals are given to the same elements, and overlapping description will be omitted.

The magnetic body layer M4 is positioned on the side opposite to the magnetic body layer M1 in the stacking direction. Thus, the conductor layer L8 is a conductor layer closest to the magnetic body layer M4, and the conductor layer L1 is a conductor layer farthest from the magnetic body layer M4. The presence of the magnetic body layer M4 may cause a short-circuit failure, through the magnetic body layer M4, between the terminal patterns 81, 82 belonging to the primary side and the coil pattern 80 or terminal patterns 83, 84 belonging to the secondary side; however, when the interlayer insulating film 98 covering the conductor layer L8 has a sufficient film thickness, such a problem does not occur. That is, the short-circuit failure through the magnetic body layer M4 can be prevented by making a film thickness T8 of the interlayer insulating film 98 larger than a film thickness TO of the interlayer insulating film 90. The film thickness T8 of the interlayer insulating film 98 is defined by the film thickness at a position where the conductor layer L8 is provided.

### Fourth Embodiment

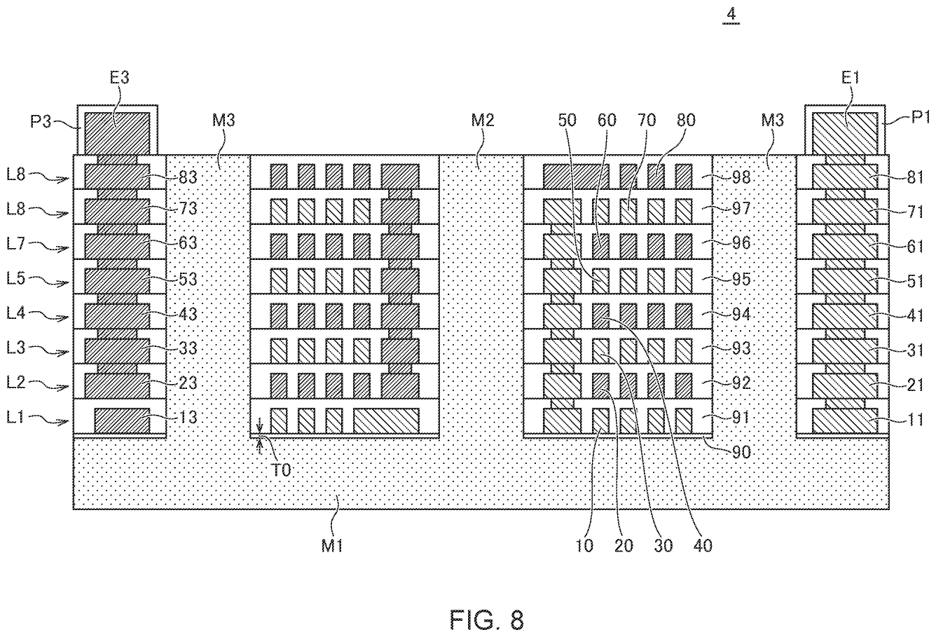

FIG. 8 is a schematic cross-sectional view for explaining the structure of a coil component 4 according to a fourth embodiment of the present invention, which corresponds to the cross section illustrated in FIG. 2.

As illustrated in FIG. 8, the coil component 4 according to the fourth embodiment differs from the coil component 1 according to the first embodiment in that all the terminal patterns are embedded in the interlayer insulating films 91 to 98 and are not exposed at their side surfaces. Other basic configurations are the same as those of the coil component 1 according to the first embodiment, so the same reference numerals are given to the same elements, and overlapping description will be omitted. As exemplified in the present embodiment, the side surface of the terminal pattern may not necessarily be exposed. In this case, a solder fillet is not formed at the time of mounting, allowing higher density mounting.

### Fifth Embodiment

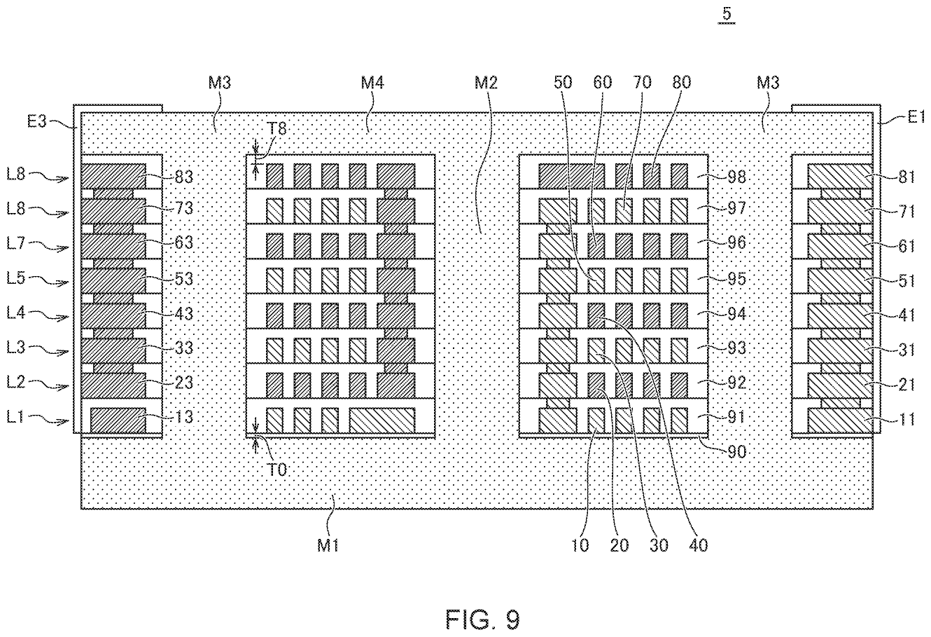

FIG. 9 is a schematic cross-sectional view for explaining the structure of a coil component 5 according to a fifth embodiment of the present invention, which corresponds to the cross section illustrated in FIG. 2.

As illustrated in FIG. 9, the coil component 5 according to the fifth embodiment differs from the coil component 3 according to the third embodiment in that the terminal electrodes E1 to E4 do not have a bump shape but are provided at the side surfaces of the interlayer insulating films 91 to 98. Other basic configurations are the same as those of the coil component 3 according to the third embodiment, so the same reference numerals are given to the same elements, and overlapping description will be omitted.

In the present embodiment, the terminal electrodes E1 to E4 are formed by applying a resin material containing a conductive member to the side surfaces of the interlayer insulating film 91 to 98 and the surface of the magnetic body layer M4. In the cross section illustrated in FIG. 9, the terminal electrode E1 is connected to the terminal patterns 11, 21, 31, 41, 51, 61, 71, and 81 exposed to first side surfaces of the respective interlayer insulating films 91 to 98, and the terminal electrode E2 is connected to the terminal patterns 23, 33, 43, 53, 63, 73, and 83 exposed to second side surfaces of the respective interlayer insulating films 92 to 98. As exemplified in the present embodiment, the terminal electrode may not necessarily have a bump shape.

While the preferred embodiment of the present disclosure has been described, the present disclosure is not limited to the above embodiment, and various modifications may be made within the scope of the present disclosure, and all such modifications are included in the present disclosure.

For example, although the coil components 1 to 4 according to the above embodiments each have eight conductor layers L1 to L8, the number of conductor layers is not limited to this. Further, it is not essential that two coil patterns positioned in mutually different conductor layers are connected in parallel. Further, the coil component according to the present invention is not limited in application to a balun transformer but may be applied to any coil component that has a plurality of electrically insulated coil patterns.

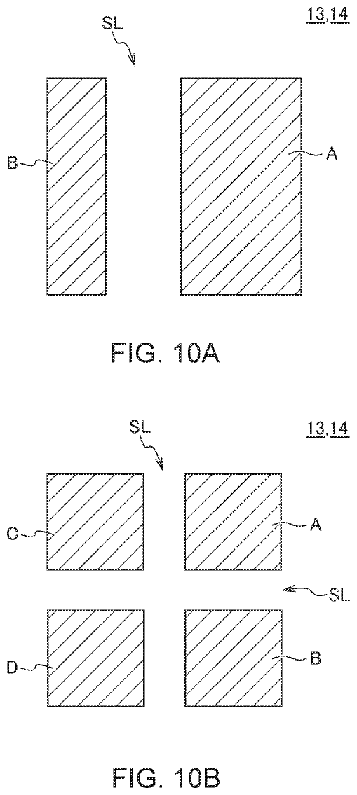

Further, the terminal patterns 13 and 14 each need not be formed in a single pattern but may each be divided into two patterns A and B by a slit SL as illustrated in FIG. 10A, or into four patterns A to D by a slit SL as illustrated in FIG. 10B.

### REFERENCE SIGNS LIST

1-5 coil component
10, 20, 30, 40, 50, 60, 70, 80 coil pattern
11-14, 21-24, 31-34, 41-44, 51-54, 61-64, 71-74, 81-84 terminal pattern
15 dummy pattern
25, 35, 45, 55, 65, 75 relay pattern
90-98 interlayer insulating film
A-D pattern
E1-E4 terminal electrode
L1-L8 conductor layer
M1-M4 magnetic body layer
P1-P4 barrel plating layer
SL slit

1-8. (canceled)

9. A coil component comprising:
a first magnetic body layer; and
a plurality of interlayer insulating films and a plurality of conductor layers alternately stacked on the first magnetic body layer,
wherein the plurality of conductor layers include a first conductor layer closest to the first magnetic body layer, a second conductor layer farthest from the first magnetic body layer, and a plurality of third conductor layers disposed between the first conductor layer and the second conductor layer,
wherein the plurality of interlayer insulating films include a first interlayer insulating film disposed between the first magnetic body layer and the first conductor layer, a second interlayer insulating film covering the second conductor layer, and a plurality of third interlayer insulating films disposed between the first interlayer insulating film and the second interlayer insulating film,
wherein each of the plurality of conductor layers includes a coil pattern, a first terminal pattern, and a second terminal pattern,
wherein the first terminal pattern included in the first conductor layer, the first terminal pattern included in the second conductor layer, and the first terminal pattern included in each of the plurality of third conductor layers are connected to one another through via conductors penetrating respectively the plurality of third interlayer insulating films,
wherein the second terminal pattern included in the second conductor layer and the second terminal pattern included in each of the plurality of third conductor layers are connected to one another through via conductors penetrating respectively the plurality of third interlayer insulating films, and
wherein the second terminal pattern included in the first conductor layer is insulated from the second terminal pattern included in each of the plurality of third conductor layers.

10. The coil component as claimed in claim 9, further comprising:
a first terminal electrode disposed at a position overlapping, through the second interlayer insulating film, the first terminal pattern included in the second conductor layer; and
a second terminal electrode disposed at a position overlapping, through the second interlayer insulating film, the second terminal pattern included in the second conductor layer,
wherein the first terminal pattern included in the second conductor layer is connected to the first terminal electrode through a via conductor penetrating the second interlayer insulating film, and the second terminal pattern included in the second conductor layer is connected to the second terminal electrodes through a via conductor penetrating the second interlayer insulating film.

11. The coil component as claimed in claim 9, further comprising:
a first terminal electrode disposed on first side surfaces of the plurality of third interlayer insulating films; and
a second terminal electrode disposed on second side surfaces of the plurality of third interlayer insulating films,
wherein the first terminal pattern included in the first conductor layer, the first terminal pattern included in the second conductor layer, and the first terminal pattern included in each of the plurality of third conductor layers are exposed to the first side surfaces to contact the first terminal electrode, and
wherein the second terminal pattern included in the second conductor layer and the second terminal pattern included in each of the plurality of third conductor layers are exposed to the second side surfaces to contact the second terminal electrode.

12. The coil component as claimed in claim 9, wherein the second terminal pattern included in the first conductor layer is in a floating state.

13. The coil component as claimed in claim 10, wherein the second terminal pattern included in the first conductor layer is in a floating state.

14. The coil component as claimed in claim 11, wherein the second terminal pattern included in the first conductor layer is in a floating state.

15. The coil component as claimed in claim 9, wherein the second terminal pattern included in the first conductor layer is connected to the coil pattern included in the first conductor layer.

16. The coil component as claimed in claim 10, wherein the second terminal pattern included in the first conductor layer is connected to the coil pattern included in the first conductor layer.

17. The coil component as claimed in claim 11, wherein the second terminal pattern included in the first conductor layer is connected to the coil pattern included in the first conductor layer.

18. The coil component as claimed in claim 9, wherein the second terminal pattern included in the first conductor layer is embedded in the third interlayer insulating film, and a side surface of the second terminal pattern is not exposed from the third interlayer insulating film.

19. The coil component as claimed in claim 10, wherein the second terminal pattern included in the first conductor layer is embedded in the third interlayer insulating film, and a side surface of the second terminal pattern is not exposed from the third interlayer insulating film.

20. The coil component as claimed in claim 11, wherein the second terminal pattern included in the first conductor layer is embedded in the third interlayer insulating film, and a side surface of the second terminal pattern is not exposed from the third interlayer insulating film.

21. The coil component as claimed in claim 9, wherein the second terminal pattern included in the first conductor layer is divided into multiple patterns by a slit.

22. The coil component as claimed in claim 10, wherein the second terminal pattern included in the first conductor layer is divided into multiple patterns by a slit.

23. The coil component as claimed in claim 11, wherein the second terminal pattern included in the first conductor layer is divided into multiple patterns by a slit.

24. The coil component as claimed in claim 9, further comprising a second magnetic body layer covering the second conductor layer through the second interlayer insulating film,
wherein the second interlayer insulating film is thicker than the first interlayer insulating film.

25. The coil component as claimed in claim 10, further comprising a second magnetic body layer covering the second conductor layer through the second interlayer insulating film,
wherein the second interlayer insulating film is thicker than the first interlayer insulating film.

26. The coil component as claimed in claim 11, further comprising a second magnetic body layer covering the second conductor layer through the second interlayer insulating film,
wherein the second interlayer insulating film is thicker than the first interlayer insulating film.
